(19) United States
(12) Patent Application Publication
(10) Pub. No.: US 2007/0214706 A1
(43) Pub. Date: Sep. 20, 2007

(54) Apparatus which is specially hinged to easily and safely use a trolling fishing pole

(76) Inventor: Thomas Joseph Donato, Staten Island, NY (US)

Correspondence Address: THOMAS J. DONATO, 64 CLERMONT PLACE, STATEN ISLAND, NY, 10314, US

(21) Appl. No.: 11/375,324

(22) Filed: Mar. 14, 2006

(51) Int. Cl. A01K 97/10

(52) U.S. Cl. 43/21.2

(57) ABSTRACT

An apparatus which is specially hinged to easily and safely use a Trolling fishing pole with simply lift to vertical position to adjust lines or remove pole, and holds pole in proper position for trolling.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of sport fishing and more specifically to an apparatus which is specially hinged to easily and safely use a Trolling fishing pole.
rod holders that are used in trolling are normally the type that hold the fishing rod perpendicular to the center line of the boat, there by giving a greater spread to the trolled lures.
there are various other rod holders that hold the fishing rods in the same basic orientation as my holders do.
all prior fishing rod holders are of the fixed type or require special mounting hardware, or require loosening a fastener. My rod holders can go from one boat to any other boat which have standard fixed type rod holders installed, and there is nothing to tighten or loosen. The fishing pole is inserted with the holders in the vertical position and then simply allow the holder to go to the horizontal, or outboard position.

### BRIEF SUMMARY OF THE INVENTION

The primary object of the invention is an internally hinged fishing rod holder for trolling.

Another object of the invention is made entirely of corrosion free materials.

Another object of the invention is there is no special mounting necessary.

A further object of the invention is it fits into integral pole holders of the boat.

Yet another object of the invention is to easily remove a fish loaded pole from holder.

Still yet another object of the invention is there is no reaching out over side of boat thereby eliminating the chance of injury.

Another object of the invention is it can easily and safely change the length of the fishing line.

Another object of the invention is there is nothing to tighten or loosen to return to fishing position.

Another object of the invention is that it can be transfered from one boat to any other boat.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an apparatus which is specially hinged to easily and safely use a Trolling fishing pole comprising: simply lift to vertical position to adjust lines or remove pole, and holds pole in proper position for trolling.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

Figure <n> is a perspective view of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

This invention relates generally to the field of sport fishing and more specifically to an apparatus which is specially hinged to easily and safely use a Trolling fishing pole,from a boat, with little effort.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

The drawings constitute a part of this specification and include exemplary embodiments to the invention, which may be embodied in various forms. It is to be understood that in some instances various aspects of the invention may be shown exaggerated or enlarged to facilitate an understanding of the invention.

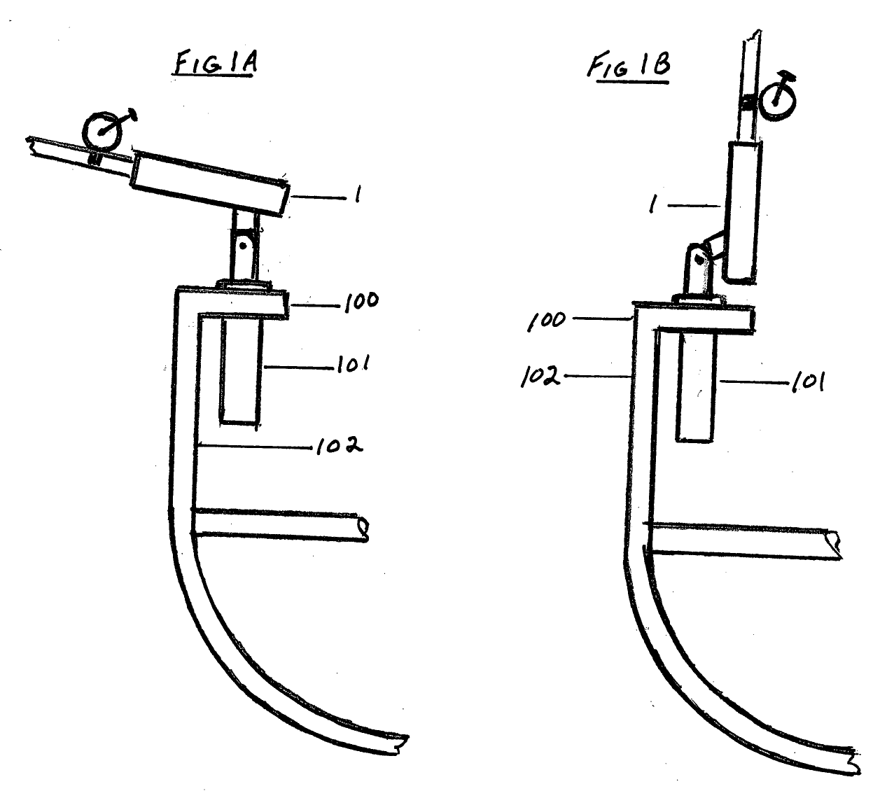

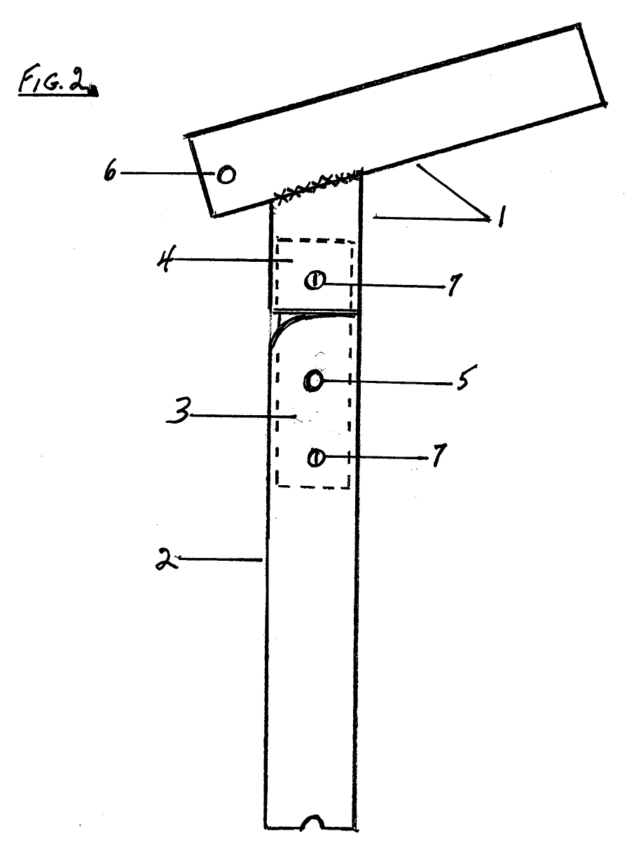

Drawing page 1/7, FIG. 1A depicts the apparatus in the horizontal position. FIG. 1B depicts the apparatus in the vertical position. Both FIG. 1A and FIG. 1B are shown mounted in the gunwale of a boat.

Drawing page 2/7 depicts the apparatus in the horizontal position with individual parts numbered and named.

Drawing page 3/7 depicts the apparatus in the vertical position with individual parts numbered.

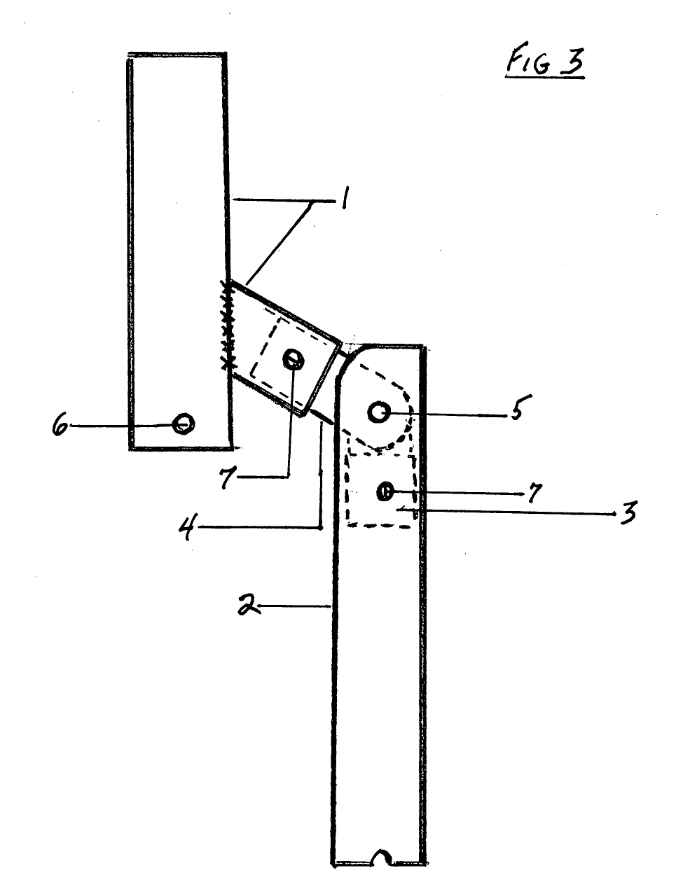

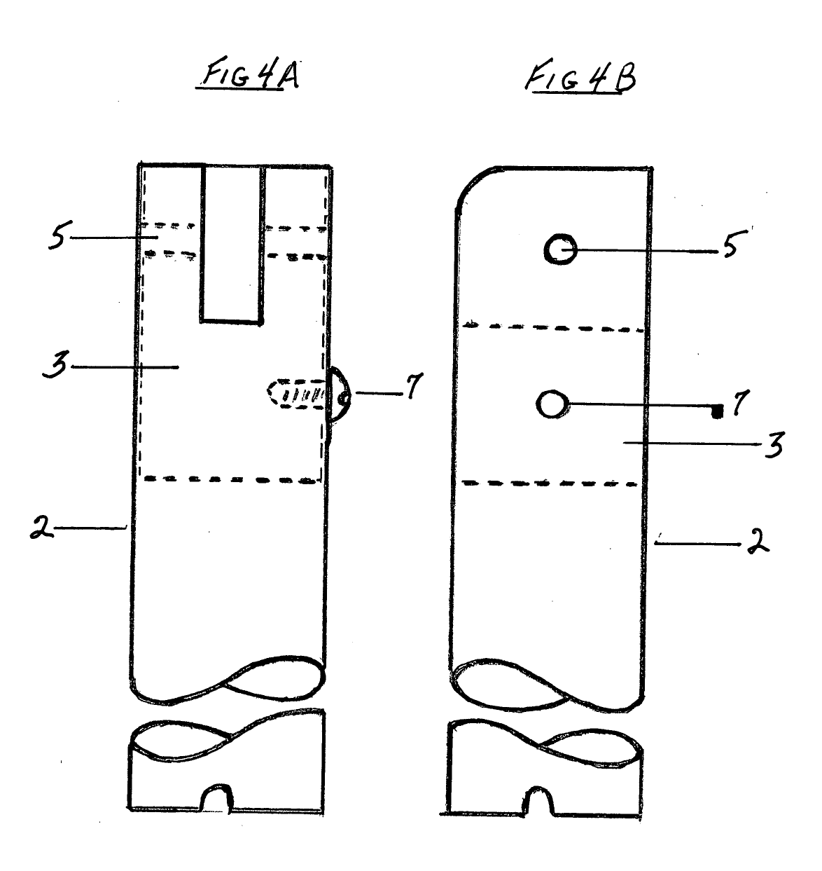

Drawing page 4/7, FIG. 4A depicts the front view of vertical tube (part 2) with the insert (part 3 lower section) installed. FIG. 4B depicts the side view of same.

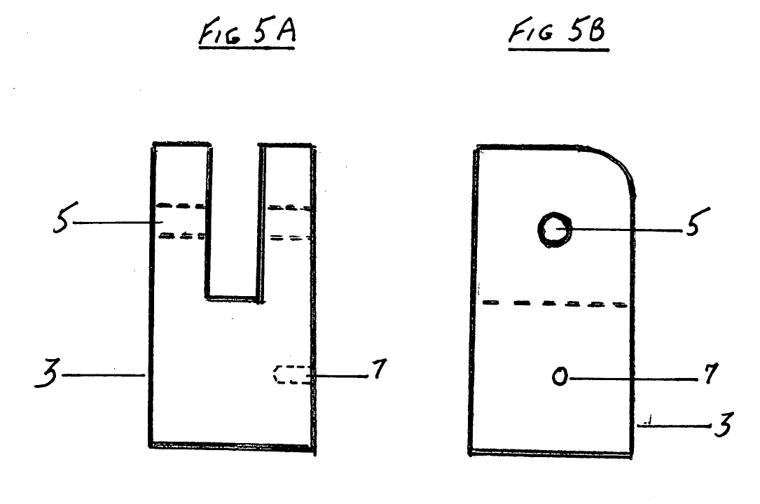

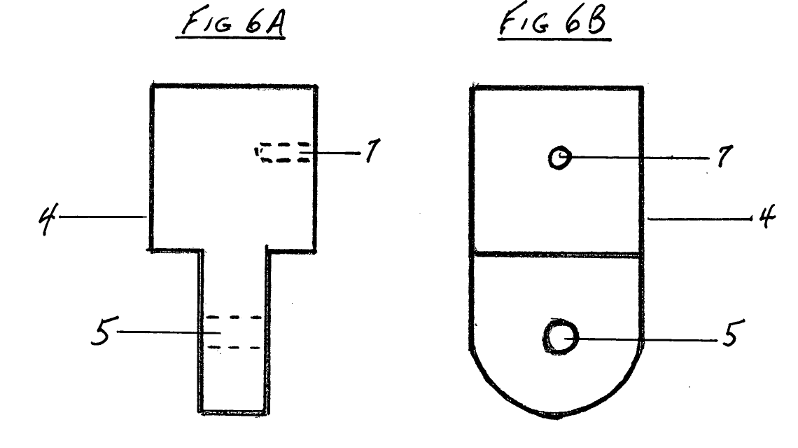

Drawing page 5/7, FIG. 5A depicts the front view of insert (lower section) part 3. FIG. 5B depicts the side view of same.

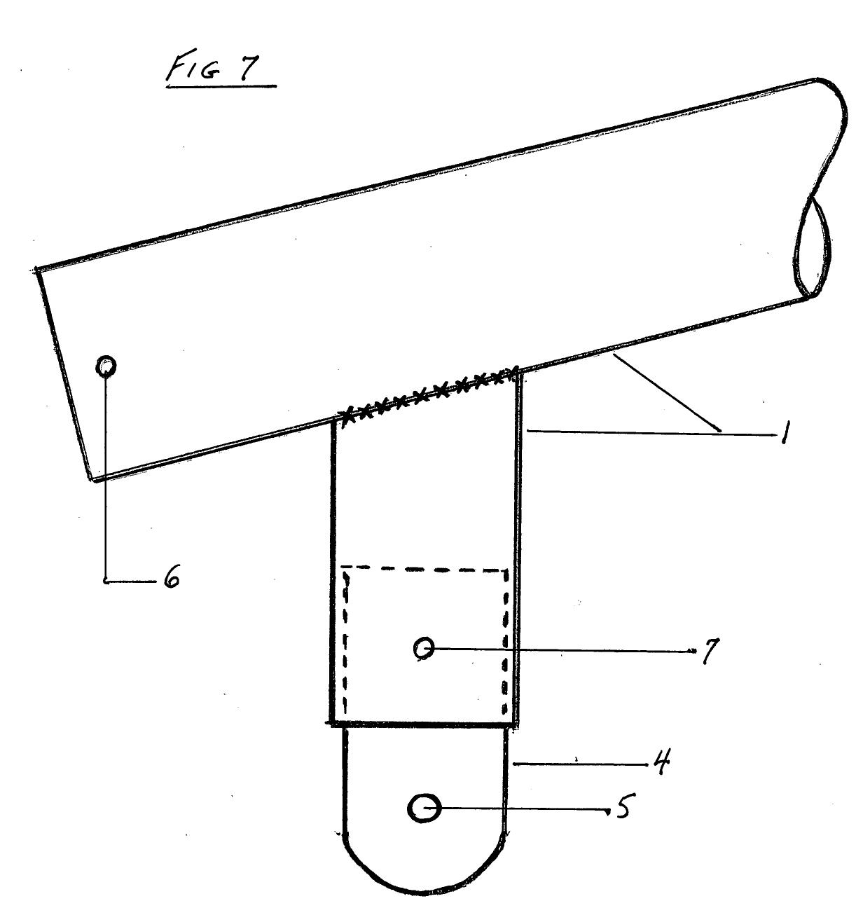

Drawing page 6/7, FIG. 6A depicts the front view of insert (upper section) part 4. FIG. 6B depicts the side view of same.

Drawing page 7/7 depicts rod holder welded assembly (part 1) with insert (upper section) part 4 installed.

1. An apparatus which is specially hinged to easily and safely use a trolling fishing pole comprising: simply lift to vertical position to adjust lines or remove pole; and holds pole in proper position for trolling.

2. A rod holder assembly comprised of:
An upper welded rod holder assembly that accepts the butt end of a fishing pole therein.
A pivot segment (labeled “insert” in drawings) comprised of two parts, the top of which is secured into the upper welded rod holder assembly, the bottom of which is secured into a stationary lower vertical tube, which in turn is inserted into existing standard equipment boat rod holder, and held in place by existing gimbal- pin engaging notch in lower vertical tube.

3. A rod holder assembly containing a two-part hinge apparatus, connected together by means of a pivot pin. Said apparatus is thereby inserted into and screwed (or pinned) to a lower vertical tube and upper welded rod holder assembly.

4. A rod holder assembly allowing the user to easily remove, or replace a fishing pole simply by lifting to vertical and removing said fishing pole (without the need to move or loosen any other hardware) within the confines of the boat.

5. A rod holder assembly allowing for adjustments of line length or drag setting in a safe manner without having to lean overboard of boat, by simply lifting to vertical.

6. A rod holder assembly, which when used as described, in the horizontal position, holds a fishing pole securely, in a position, conducive to trolling, thereby maximizing the spread of trolled lures to center-line of boat.
